(19) United States
(12) Patent Application Publication
(10) Pub. No.: US 2009/0192253 A1
(43) Pub. Date: Jul. 30, 2009

(54) RECYCLABLE TOOLING COMPOSITIONS AND METHODS OF THEIR MANUFACTURE AND USE

(76) Inventors: Paul Willey, Clifton Park, NY (US); Nathan Doyle, Troy, NY (US); Josephine Faler, Burnt Hills, NY (US); Johnny Lohmiller, Horb (DE); Richard Schlansker, Amsterdam, NY (US); Jing Wang, Simpsonville, SC (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/257,288

(22) Filed: Oct. 23, 2008

Related U.S. Application Data
(60) Provisional application No. 60/982,056, filed on Oct. 23, 2007.

(51) Int. Cl. C08L 67/04; C08K 3/26; C08K 3/08; C08L 53/00

(52) U.S. Cl. 524/425; 525/411; 524/539; 524/441; 525/95

(57) ABSTRACT

This invention relates generally to compositions of macrocyclic polyester oligomer (MPO), polycaprolactone, and a thermoplastic elastomer (TPE). More particularly, in certain embodiments, the invention relates to recyclable tooling compositions made from MPO, polycaprolactone, and a thermoplastic copolyester elastomer.

### RELATED APPLICATIONS

This application claims benefit of U.S. Provisional Patent Application No. 60/982,056, filed on Oct. 23, 2007, the text of which is incorporated herein by reference in its entirety. This application incorporates by reference the text of U.S. Pat. No. 6,960,626, issued Nov. 1, 2005, and the text of U.S. patent application Ser. No. 11/607,464, filed Dec. 1, 2006, and published as US2007/0216067.

### FIELD OF THE INVENTION

This invention relates generally to compositions of macrocyclic polyester oligomer (MPO), polycaprolactone, and a thermoplastic elastomer (TPE). More particularly, in certain embodiments, the invention relates to recyclable tooling compositions made from MPO, polycaprolactone, and a thermoplastic polyester elastomer.

### BACKGROUND OF THE INVENTION

Tooling blocks are cast composites that can be cut to produce prototype parts for the aerospace, automotive, and electronics industries. Current tooling materials, such as polyurethanes, are not recyclable, they require use of volatiles and/or toxic materials in their production, and they may not have adequate solvent and/or abrasion resistance.

There is a need for tooling block compositions that are recyclable, that are less hazardous to manufacture than polyurethanes, and that have improved solvent and/or abrasion resistance, while still offering satisfactory modulus and other mechanical properties.

### SUMMARY OF THE INVENTION

Tooling block compositions made with macrocyclic polyester oligomer (MPO) exhibit good machining properties, good solvent resistance, good abrasion resistance, high thermal stability, and low CTE. MPO-based tooling compositions also can be recycled, unlike polyurethanes. The use of MPO in manufacturing tooling compositions offers various advantages, such as low environmental impact (e.g., low/no volatiles, low/no toxicity) and low CTE. MPO may be cast into large and/or complex shapes, due to its unique, low, water-like processing viscosities.

For example, cyclic polybutylene terephthalate (cPBT) is a low viscosity (at processing temperatures), castable MPO that converts to polybutylene terephthalate (PBT) upon curing. No volatiles or toxic materials are involved in the manufacturing process, and the PBT product is a thermoplastic which can be re-used, for example, in compounding and/or injection molding applications.

Tooling block compositions made from MPO alone may not provide sufficiently low modulus, sufficient toughness and/or sufficient abrasion resistance for all applications. It is found that the addition of polycaprolactone (PCL) and an engineering thermoplastic elastomer (e.g., Pibiflex) provides the resulting formulation with improved toughness, improved sand abrasion resistance, and modulus (including dynamic modulus curves) similar to that of polyurethane. The improvement in properties is greater than would be expected using either PCL or thermoplastic elastomer alone as a single MPO filler. The synergistic effect of the two components in MPO has been experimentally observed, as described herein.

Further embodiments also add a hollow filler (e.g., microspheres and/or nanospheres); calcium carbonate, and/or aluminum (e.g., aluminum powder) to the MPO composition. Syntactic foams may be prepared from MPO and a hollow filler, and may advantageously include PCL and thermoplastic elastomer. It is notable that compositions having low CTE can be made with these fillers.

The compositions described herein are not limited to tooling block compositions, but may also be used, for example, as foam gaskets, casting resins, electro-casting resins, adhesives, and spray molding compositions.

In one aspect, the invention relates to a composition including: (a) macrocyclic polyester oligomer; (b) polycaprolactone; and (c) a thermoplastic elastomer. In certain embodiments, the macrocyclic polyester oligomer includes one or more of the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and/or copolyester oligomer comprising two or more monomer repeat units.

In certain embodiments, the composition further includes a hollow filler (e.g., microspheres and/or nanospheres), calcium carbonate, and/or aluminum (e.g., aluminum powder). In certain embodiments, the thermoplastic elastomer includes one or more of the following: styrenic block copolymer, polyolefin blend, elastomeric alloy, thermoplastic polyurethane, thermoplastic copolyester, and/or thermoplastic polyamide. In certain embodiments, the thermoplastic elastomer is a thermoplastic polyester elastomer, for example, a thermoplastic copolyester elastomer.

In certain embodiments, the composition contains at least 50 wt. % macrocyclic polyester oligomer (MPO), at least 5 wt. % polycaprolactone (PCL), and at least 5 wt. % thermoplastic elastomer. In other embodiments, the minimum amounts of MPO, PCL, and thermoplastic elastomer, respectively, in the composition are as follows (in wt. %): 55/5/5; 60/5/5; 65/5/5; 70/5/5; 75/5/5; 80/5/5; 85/5/5; 90/5/5; 45/5/5; 40/5/5; 35/5/5; 30/5/5; 25/5/5; 20/5/5; 15/5/5; 10/5/5; 5/5/5; 55/3/3; 60/3/3; 65/3/3; 70/3/3; 75/3/3; 80/3/3; 85/3/3; 90/3/3; 50/3/3; 40/3/3; 35/3/3; 30/3/3; 25/3/3; 20/3/3; 15/3/3; 10/3/3; 5/3/3; 55/7/7; 60/7/7; 65/7/7; 70/7/7; 75/7/7; 80/7/7; 85/7/7; 90/7/7; 50/7/7; 40/7/7; 35/7/7; 30/7/7; 25/7/7; 20/7/7; 15/7/7; 10/7/7; and/or 5/7/7.

In certain embodiments, the composition is used to prepare a tooling block, for example, a recyclable tooling block. In other embodiments, the composition is used as, or used to make, foam gaskets, casting resins, electro-casting resins, adhesives, and/or spray molding compositions. In certain embodiments, the composition, upon polymerization, exhibits low CTE (e.g., at high temperature), and/or exhibits modulus at 30° C. (by DMA) of no greater than about 2.5 GPa, no greater than about 2.0 GPa, no greater than about 1.5 GPa, or no greater than about 1.0 GPa. In certain embodiments, upon polymerization, the composition exhibits high abrasion resistance (e.g., sandpaper abrasion weight loss, ISO-4649, of no greater than about 300 mg, no greater than about 250 mg, no greater than about 200 mg, or no greater than about 150 mg). In certain embodiments, upon polymerization, the composition exhibits high solvent resistance (e.g., solvent swell in 80° C. triethyl amine, linear %, of no greater than about 4%, no greater than about 3%, no greater than about 2%, no greater than about 1%, or no greater than about 0.5%).

The description of elements of the embodiments of other aspects of the invention can be applied to this aspect of the invention as well.

In another aspect, the invention relates to a method for preparing a composite, the method comprising the step of contacting: (a) macrocyclic polyester oligomer; (b) polycaprolactone; (c) a thermoplastic elastomer, and, optionally, (d) a hollow filler. In certain embodiments, the method further includes the step of polymerizing the macrocyclic polyester oligomer. In certain embodiments, the macrocyclic polyester oligomer includes one or more of the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and/or copolyester oligomer comprising two or more monomer repeat units. In certain embodiments, the thermoplastic elastomer includes one or more of the following: styrenic block copolymer, polyolefin blend, elastomeric alloy, thermoplastic polyurethane, thermoplastic copolyester, and/or thermoplastic polyamide. In certain embodiments, the thermoplastic elastomer is a thermoplastic polyester elastomer, for example, a thermoplastic copolyester elastomer.

In certain embodiments, the composite is used to prepare a tooling block, for example, a recyclable tooling block. In other embodiments, the composite is used as, or used to make, foam gaskets, casting resins, electro-casting resins, adhesives, and/or spray molding compositions.

In certain embodiments, the composite, upon polymerization, exhibits low CTE (e.g., at high temperature), and/or exhibits modulus at 30° C. (by DMA) of no greater than about 2.5 GPa, no greater than about 2.0 GPa, no greater than about 1.5 GPa, or no greater than about 1.0 GPa. In certain embodiments, upon polymerization, the composite exhibits high abrasion resistance (e.g., sandpaper abrasion weight loss, ISO-4649, of no greater than about 300 mg, no greater than about 250 mg, no greater than about 200 mg, or no greater than about 150 mg). In certain embodiments, upon polymerization, the composite exhibits high solvent resistance (e.g., solvent swell in 80° C. triethyl amine, linear %, of no greater than about 4%, no greater than about 3%, no greater than about 2%, no greater than about 1%, or no greater than about 0.5%).

In certain embodiments, the composite further includes a hollow filler (e.g., microspheres and/or nanospheres), calcium carbonate, and/or aluminum (e.g., aluminum powder).

In certain embodiments, the composite contains at least 50 wt. % macrocyclic polyester oligomer (MPO), at least 5 wt. % polycaprolactone (PCL), and at least 5 wt. % thermoplastic elastomer. In other embodiments, the minimum amounts of MPO, PCL, and thermoplastic elastomer, respectively, in the composite are as follows (in wt. %): 55/5/5; 60/5/5; 65/5/5; 70/5/5; 75/5/5; 80/5/5; 85/5/5; 90/5/5; 45/5/5; 40/5/5; 35/5/5; 30/5/5; 25/5/5; 20/5/5; 15/5/5; 10/5/5; 5/5/5; 55/3/3; 60/3/3; 65/3/3; 70/3/3; 75/3/3; 80/3/3; 85/3/3; 90/3/3; 50/3/3; 40/3/3; 35/3/3; 30/3/3; 25/3/3; 20/3/3; 15/3/3; 10/3/3; 5/3/3; 55/7/7; 60/7/7; 65/7/7; 70/7/7; 75/7/7; 80/7/7; 85/7/7; 90/7/7; 50/7/7; 40/7/7; 35/7/7; 30/7/7; 25/7/7; 20/7/7; 15/7/7; 10/7/7; and/or 5/7/7.

The description of elements of the embodiments of other aspects of the invention can be applied to this aspect of the invention as well.

### BRIEF DESCRIPTION OF THE DRAWINGS

The objects and features of the invention can be better understood with reference to the drawing described below, and the claims.

FIG. 1 is a graph showing Dynamic Mechanical Analysis (DMA) modulus curves for several formulations according to illustrative embodiments of the invention.

### DETAILED DESCRIPTION

It is contemplated that compositions, mixtures, systems, methods, and processes of the claimed invention encompass variations and adaptations developed using information from the embodiments described herein. Adaptation and/or modification of the compositions, mixtures, systems, methods, and processes described herein may be performed by those of ordinary skill in the relevant art.

Throughout the description, where systems are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited processing steps.

Similarly, where mixtures and compositions are described as having, including, or comprising specific compounds and/or materials, it is contemplated that, additionally, there are mixtures and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

CBT® Resin-based materials are excellent candidates for tooling block due to, among other things, their outstanding machining properties, solvent resistance, thermal stability, ability to be cast into large and/or complex shapes, low environmental impact and relatively low CTE (CBT® Resin is macrocyclic polybutylene terephthalate, cPBT, manufactured by Cyclics Corporation of Schenectady, N.Y.). We have identified a combination of at least two copolymer modifiers that largely retain these properties while improving other key properties—these modifiers are polycaprolactone (PCL) and a thermoplastic elastomeric copolyester (e.g., Pibiflex 3512NAT, manufactured by P-Group). CBT® resin is an excellent candidate for use as a tooling block but some applications require lower modulus, improved toughness and better sand abrasion resistance than CBT® alone can provide. The addition of PCL and thermoplastic elastomer addressed these needs.

The six generic classes of thermoplastic elastomers (TPEs) which may be used in various embodiments of the invention are as follows: styrenic block copolymers, polyolefin blends, elastomeric alloys, thermoplastic polyurethanes, thermoplastic copolyester, and thermoplastic polyamides. The characteristics of TPEs that distinguish them from other materials include their ability to be stretched (when solid) and return to approximately their original shape, their processibility as a melt at elevated temperature, and absence of significant creep. Examples of TPE, in addition to Pibiflex, are Styroflex (manufactured by BASF, Ludwigshafen, Germany), Kraton (Shell chemicals, Houston, Tex.), Pellethane (Dow chemical, Midland, Mich.), Pebax (DSM, Heerlen, the Netherlands), Arnitel (DSM), Hytrel (Du Pont, Wilmington, Del.), Santoprene (Monsanto), Geolast (Monsanto, Creve Coeur, Mo.), and Alcryn (Du Pont).

CBT® resin is a low viscosity, castable material that on curing converts to polybutylene terephthalate (PBT). No volatiles or toxic materials are involved in the process and the product, PBT, is a thermoplastic which can be recycled. Table 1 shows select mechanical properties of cPBT resin, as well as copolymer-modified cPBT resin, relative to a standard polyurea tooling block product (Ebalta Ureol 6417). The copolymer-modified cPBT in Table 1 is made by adding 10 parts per hundred (pph) of Pibiflex 3512NAT elastomeric copolyester (manufactured by P Group, Munich, Germany) and 10 pph CAPA6506 polycaprolactone (PCL) (manufactured by Solvay) to cPBT, then cast into a block or panel (according to the respective mechanical test) and polymerized. Testing parts were cut and/or machined from the block/panel. The copolymer-modified cPBT formulation (with both PCL and thermoplastic elastomer added) has mechanical properties comparable to those of a polyurethane tooling block, with the additional advantages of better solvent and abrasion resistance, and lower environmental impact.

TABLE 1
Mechanical properties of copolymer-modified cPBT,
compared to unmodified cPBT and polyurea

| | CTE (ASTM | Sandpaper | | | Solvent Swell |
|---|---|---|---|---|---|
| | E831, 23 to | Abrasion | Modulus at | | in 80 deg C. |
| | 80 deg C., | Weight Loss, | 30 deg C. by | Hardness | triethyl amine |
| Sample | ppm/deg C.) | (ISO-4649, mg) | DMA (GPa) | (Shore D) | (linear %) |
| CBT ® Resin | 106 | 140 | 2.9 | 83 | 0.1 |
| Polyurea | 162 | 410 | 0.9 | 63 | 5.3 |
| Copolymer | 162 | 2 | 1.0 | 70 | 0.5 |
| Modified | | | | | |
| CBT ® Resin | | | | | |

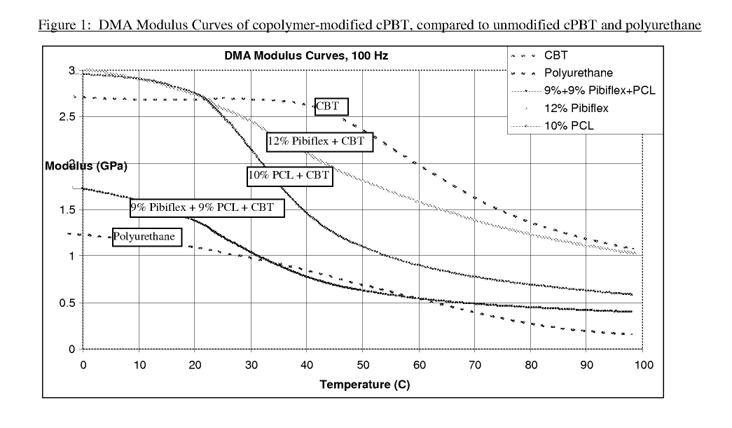

FIG. 1 shows Dynamic Mechanical Analysis (DMA) modulus curves for several formulations. The red and purple dotted lines represent unmodified CBT® (cPBT) resin and polyurethane respectively (cast and polymerized). The gold and green are the modulus curves of cPBT with individually-added Pibiflex (about 12 wt. % Pibiflex with about 88 wt. % cPBT) and PCL (about 10 wt. % PCL with about 90 wt. % cPBT), respectively. Finally, the blue curve is the modulus of the combination of Pibiflex and PCL with cPBT (about 9.1 wt. % cPBT, about 9.1 wt. % PCL, and about 81.8 wt. % cPBT). This curve clearly shows that Pibiflex and polycaprolactone synergistically combine to make a product with similar mechanical properties to the polyurea.

### Experimental Examples

The following example illustrates how the samples shown in Table 1 and FIG. 1 were prepared.

A 250 mL three neck round bottom flask was charged with 147.3 grams of CBT100® resin and 0.54 grams of Ethanox 330 antioxidant (manufactured by Albemarle). The flask was fitted with an overhead mechanical stirrer, an inlet to alternate between vacuum and a nitrogen blanket, and a thermometer to read the solution temperature. Vacuum was applied to the flask and it was put into a silicone oil bath at 210 C. The CBT100® melted to a clear, light brown low viscosity liquid.

The flask was vented to nitrogen and 16.4 grams of CAPA 6506 polycaprolactone powder was added to the stirred liquid. Vacuum was applied and the solution was stirred to allow the PCL to completely dissolve.

The flask was vented to nitrogen and 16.4 grams of Pibiflex 3512NAT pellets were added with stirring. It is preferable to keep the solution agitated during this addition to prevent the pellets from sticking to each other and the side of the flask.

The solution was stirred under vacuum at 200 C (bath 210 C) for an hour to ensure that the PCL and Pibiflex were completely dissolved. Then the solution temperature was carefully adjusted to 190 C.

Meanwhile, a small mold was thoroughly cleaned and treated with mold release (Zyvax Watershield). The mold was put into an oven and preheated to 200 C.

With the solution temperature at 190 C and the mold preheated, the flask was vented to nitrogen. 1.23 grams of Fascat 4102 catalyst (manufactured by Arkema) was added to the stirred mixture. Vacuum was applied slowly in order to maintain control over foaming. The mixture was rapidly stirred under vacuum for 90 seconds.

Stirring was stopped, the flask was vented to nitrogen, the apparatus was disassembled then the solution was carefully poured into the hot mold. The mold was quickly returned to the oven. The solution is preferably maintained above 185 C throughout the process.

The part was cured for 7 hours at 200 C.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A composition comprising:
(a) macrocyclic polyester oligomer;
(b) polycaprolactone; and
(c) a thermoplastic elastomer.

2. The composition of claim 1, wherein the macrocyclic polyester oligomer comprises at least one member selected from the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

3. The composition of claim 1, further comprising at least one member selected from the following: a hollow filler (e.g., microspheres and/or nanospheres); calcium carbonate;
and/or aluminum (e.g., aluminum powder).

4. The composition of claim 3, wherein the composition exhibits low CTE (e.g., at high temperature).

5. The composition of claim 1, wherein at least 50 wt. % of the composition is the macrocyclic polyester oligomer, at least 5 wt. % of the composition is the polycaprolactone, and at least 5 wt. % of the composition is the thermoplastic elastomer.

6. A tooling block (e.g., recyclable tooling block) made from the composition of claim 1.

7. A method for preparing a composite, the method comprising the step of contacting:
(a) macrocyclic polyester oligomer;
(b) polycaprolactone;
(c) a thermoplastic elastomer, and, optionally,
(d) a hollow filler.

8. The method of claim 7, further comprising the step of polymerizing the macrocyclic polyester oligomer.

9. The method of claim 7, wherein the macrocyclic polyester oligomer comprises at least one member selected from the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

10. A tooling block (e.g., recyclable tooling block) made from the method of claim 7.

11. The composition of claim 1, wherein the thermoplastic elastomer comprises at least one member selected from the group consisting of styrenic block copolymer, polyolefin blend, elastomeric alloy, thermoplastic polyurethane, thermoplastic copolyester, and thermoplastic polyamide.

12. The method of claim 7, wherein the thermoplastic elastomer comprises at least one member selected from the group consisting of styrenic block copolymer, polyolefin blend, elastomeric alloy, thermoplastic polyurethane, thermoplastic copolyester, and thermoplastic polyamides.

13. The composition of claim 1, wherein the thermoplastic elastomer is a thermoplastic polyester elastomer.

14. The composition of claim 1, wherein the thermoplastic elastomer is a thermoplastic copolyester elastomer.
